(19) United States
(12) Patent Application Publication
(10) Pub. No.: US 2013/0192855 A1
(43) Pub. Date: Aug. 1, 2013

(54) Interlocking Basket for Strip Tillage Machine

(71) Applicant: AGCO Corporation, Duluth, GA (US)

(72) Inventor: Roger L. Meek, Beloit, KS (US)

(73) Assignee: AGCO CORPORATION, Duluth, GA (US)

(21) Appl. No.: 13/754,909

(22) Filed: Jan. 31, 2013

Related U.S. Application Data
(60) Provisional application No. 61/593,089, filed on Jan. 31, 2012.

(51) Int. Cl. A01B 27/00; A01B 49/02

(52) U.S. Cl. CPC A01B 27/005; A01B 49/027
USPC 172/146; 172/548

(57) ABSTRACT

A strip tillage implement for movement over a crop berm has a frame configured to carry a coulter, a row cleaner, a shank and closing discs. The implement includes a basket assembly located behind the closing discs having a downwardly and rearwardly directed basket drawbar that forks into left and right support arms. The basket assembly includes a left basket half section rotatably attached to the left support arm and a right basket half section rotatably attached to the right support arm of the basket drawbar in cantilever fashion. Each of the basket half sections includes a support plate and a plurality of clod-breaking tines spaced about the periphery of the plate. Each plate is substantially perpendicular to the axis of its respective support arms such that the two plates form an upwardly diverging angle with the drawbar acting between the basket half sections to clean residue collected between the half sections.

### BACKGROUND OF THE INVENTION

1. Field of Invention

This invention relates generally to strip tillage implements and, more specifically, to rolling basket structure for such implements.

2. Description of Related Art

Numerous growers are changing from conventional tillage methods to strip tillage methods to reduce production costs and increase crop yields. Strip tillage machines typically work the soil in a zone, apply product such as fertilizer, and make a mellow, friable seedbed for the upcoming crop. Typical strip tillage machines include front coulters, row cleaners that clear residue off the strip of ground, and a shank. Trailing hillers or berm discs form a berm that is conducive to the planting and uniform germination of seeds.

A rolling basket may be attached behind the closing discs to chop up dirt clods as they roll over the berm. Some baskets have a concave cut-out to provide a berm with several inches of elevation. Other baskets utilize flat bars to make a relatively flat berm. Several types of rolling baskets are available, but most or all of such baskets encounter residue problems. Additionally, in wet conditions, dirt clods may enter the basket between the bars and plug the basket.

### OVERVIEW OF THE INVENTION

In one embodiment, the invention is directed to a strip tillage implement adapted for movement over a crop berm, the strip tillage implement having a frame configured to carry a coulter, a row cleaner, a shank and closing discs. The strip tillage implement further includes a basket assembly located behind the closing discs having a downwardly and rearwardly directed basket drawbar. A distal end of the drawbar forks into a left and a right support arm. The basket assembly includes left and right basket half sections, the left basket half section being rotatably attached to the left support arm of the basket drawbar in cantilever fashion and the right basket half section being rotatably attached to the right support arm of the basket drawbar in cantilever fashion. Each of the basket half sections includes a support plate and a plurality of clod-breaking tines spaced about the periphery of the plate. Each plate is substantially perpendicular to the axis of its respective support arms such that the two plates are arranged in an upwardly diverging angle such that the drawbar acts between the cantilevered basket half sections to clean residue collected between the basket half sections. Each clod-braking tine is an elongated member having outermost ends supported by the plate and inner ends that overlap with inner ends of clod-braking tines of the adjacent basket half section where the basket assembly interacts with the berm.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a strip tillage implement including an embodiment of an interlocking basket assembly; and.

FIG. 2 is an enlarged perspective view of the interlocking basket assembly for the strip tillage implement of FIG. 1; and

FIG. 3 is a rear view of the interlocking basket assembly for the strip tillage implement of FIG. 1.

Corresponding reference characters indicate corresponding parts throughout the views of the drawings.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

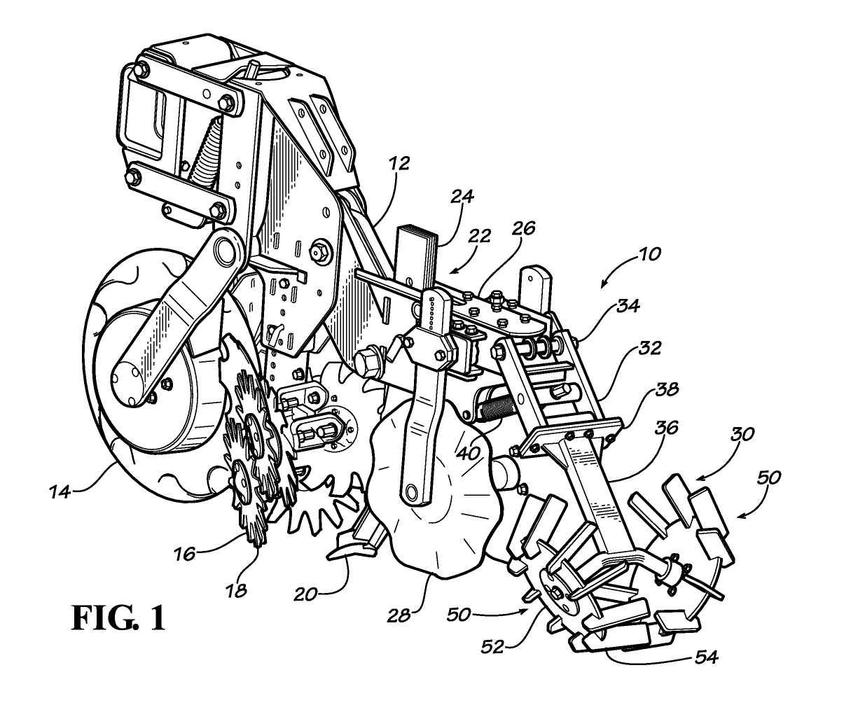

Referring now to the drawings, and more particularly to FIG. 1, there is shown a strip tillage implement 10 adapted for connection to a tractor (not shown) for forward movement at each crop berm. The strip tillage implement 10 has a frame 12 configured to carry strip tillage tools. As is known in the art, the strip tillage implement 10 includes a coulter 14 supported from the frame 12. The coulter 14 provides a centrally located slit in the berm as the strip tillage implement 10 moves across the field. The strip tillage implement 10 also includes row cleaners 16 with rearwardly diverging angled discs 18 for clearing residue from an area on opposite sides of the central slit. A shank 20 is supported from a spring trip shank assembly 22 connected by a bracket 24 to the frame 12.

A fore-and-aft extending rear support assembly 26 is connected to the frame 12. The rear support assembly 26 carries closing discs 28. An interlocking basket assembly 30 extends downwardly and rearwardly from the rear support assembly and located behind the closing discs 28. The interlocking basket assembly 30 include a bracket 32 pivotally mounted on the frame 12 at pivot 34 supporting a downwardly and rearwardly directed basket drawbar 36 at flange 38. A spring assembly 40 has an uppermost end supported by the bracket 32 and a lowermost end connected to the frame 12.

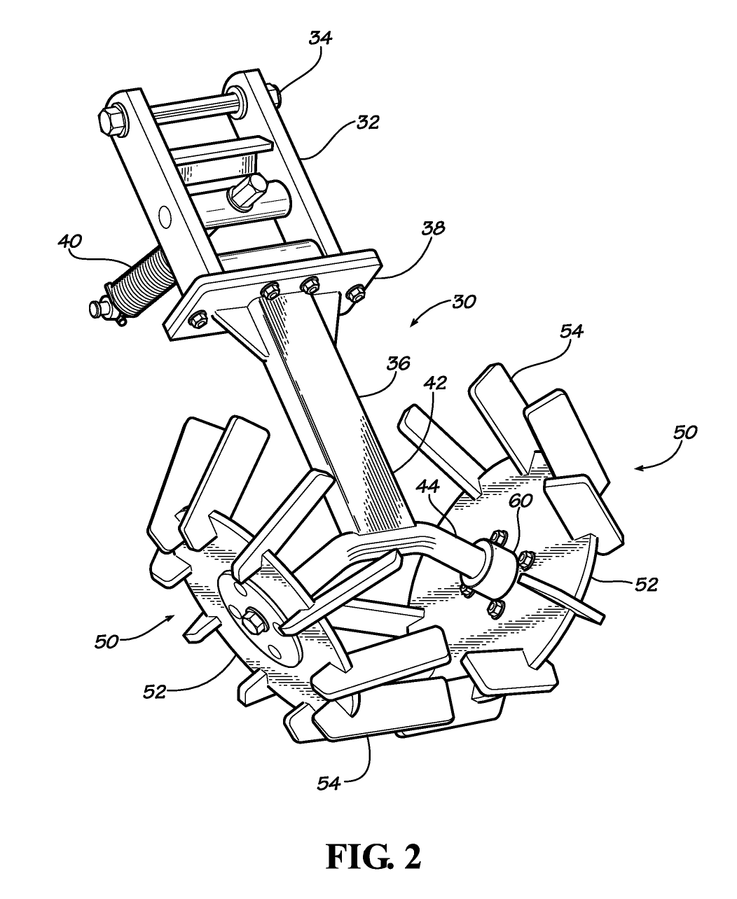

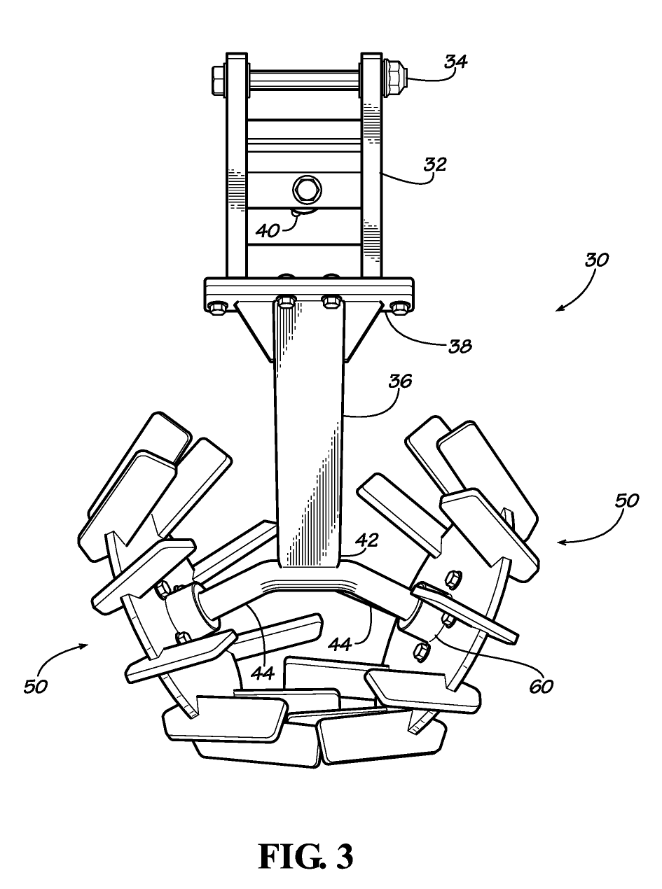

Turning now to FIGS. 2 and 3, distal end 42 of the drawbar 36 forks into two support arms 44 such that the drawbar 36 has a generally Y-shape. Each lower end of arms 44 receives an identical basket half section 50 in cantilever fashion. The basket half sections 50 each include a generally planar support plate 52 with clod-breaking members 54 spaced equidistantly about the periphery of the plate 52. The clod-braking tines 54 may be welded in slots in the outer periphery of the plate 52 or attached to the plate 52 though any other known means using sound engineering judgment. The plate 52 is substantially perpendicular to the axis of the support arms 44 such that the two plates 52 are arranged in an upwardly diverging angle as best seen in FIG. 3. Each basket half section 50 is rotatably mounted about the axis of its respective arm 44 with a bearing assembly 60 so that the basket half sections 50 rotate free of support arms 44 and the drawbar 36. In one embodiment, the bearing assembly 60 includes a single pre-lubricated and permanently sealed bearing with double row ball bearings and an inner race. However, one skilled in the art will understand that any suitable bearing assembly 60 may be used using sound engineering judgment. Therefore, as can be best appreciated from FIG. 3, the drawbar 36 acts between the cantilevered basket half sections 50 to help clean residue that collects between the basket half sections 50 of the interlocking basket assembly 30.

Each clod-braking tine 54 is an elongated member having outermost ends supported by the plate 52. Inner ends of the clod-braking tines 54 extend inward and overlap with the inner ends of the clod-braking tines 54 of the adjacent basket half section 50 where the interlocking basket assembly 30 interacts with the berm. As the basket half sections 50 rotate, the tines 54 on the diverging plates 52 separate so that they clear the drawbar 36. The tines 54 on the pair of basket half sections 50 cover a substantial portion of the berm width and can be mounted so that the interact with the berm in a generally horizontal configuration for a flat berm or angled from the horizontal to provide a shaped berm. In the mounted position shown in FIG. 3, the left basket half section 50 is generally the mirror image of the right basket half section 50.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A strip tillage implement adapted for movement over a crop berm, the strip tillage implement having a frame configured to carry a coulter, a row cleaner, a shank and closing discs, the strip tillage implement further comprising a basket assembly located behind the closing discs, the basket assembly comprising:
a downwardly and rearwardly directed basket drawbar, wherein a distal end of the drawbar forks into a left and a right support arm;
left and right basket half sections, the left basket half section being rotatably attached to the left support arm of the basket drawbar in cantilever fashion and the right basket half section being rotatably attached to the right support arm of the basket drawbar in cantilever fashion, wherein each of the basket half sections comprises a support plate and a plurality of clod-breaking tines spaced about the periphery of the plate, each plate being substantially perpendicular to the axis of its respective support arms such that the two plates are arranged in an upwardly diverging angle with the drawbar acting between the cantilevered basket half sections to clean residue collected between the basket half sections.

2. The strip tillage implement of claim 1 wherein each clod-braking tine is an elongated member having outermost ends supported by the plate and inner ends that overlap with inner ends of clod-braking tines of the adjacent basket half section where the basket assembly interacts with the berm.

3. The strip tillage implement of claim 1 wherein as the basket half sections rotate while moving over the berm, the clod-breaking tines on the diverging plates separate so that they clear the drawbar.

4. The strip tillage implement of claim 1 wherein the basket assembly comprises a bracket mounted on the frame pivotally supporting the drawbar.

5. The strip tillage implement of claim 1 wherein each basket half section is rotatably mounted about the axis of its respective arm with a bearing assembly so that the basket half sections rotate with respect to the support arms of the drawbar.

6. A basket assembly for use on a strip tillage implement adapted for movement over a crop berm, the strip tillage implement having a frame configured to carry a coulter, a row cleaner, a shank and closing discs, the strip tillage implement further comprising a basket assembly located behind the closing discs, the basket assembly comprising:
a downwardly and rearwardly directed basket drawbar, wherein a distal end of the drawbar forks into a left and a right support arm;
left and right basket half sections, the left basket half section being rotatably attached to the left support arm of the basket drawbar in cantilever fashion and the right basket half section being rotatably attached to the right support arm of the basket drawbar in cantilever fashion, wherein each of the basket half sections comprises a planar support plate and a plurality of clod-breaking tines spaced about the periphery of the plate, each plate being substantially perpendicular to the axis of its respective support arms such that the two plates are arranged in an upwardly diverging angle with the drawbar acting between the cantilevered basket half sections to clean residue collected between the basket half sections.

7. The basket assembly for a strip tillage implement of claim 6 wherein each clod-braking tine is an elongated member having outermost ends supported by the plate and inner ends that overlap with inner ends of clod-braking tines of the adjacent basket half section where the basket assembly interacts with the berm.

8. The basket assembly for a strip tillage implement of claim 6 wherein as the basket half sections rotate while moving over the berm, the clod-breaking tines on the diverging plates separate so that they clear the drawbar.

9. The basket assembly for a strip tillage implement of claim 6 wherein the basket assembly comprises a bracket mounted on the frame pivotally supporting the drawbar.

10. The basket assembly for a strip tillage implement of claim 6 wherein each basket half section is rotatably mounted about the axis of its respective arm with a bearing assembly so that the basket half sections rotate with respect to the support arms of the drawbar.
